(19) United States
(12) Patent Application Publication
(10) Pub. No.: US 2024/0324584 A1
(43) Pub. Date: Oct. 3, 2024

(54) AGENT DELIVERY IN PREDATOR/PREY ENVIRONMENTS

(71) Applicants: Larry A. BROCK, Panama City Beach, FL (US); Gary M. DENNIS, Seacrest, FL (US); Sharon D. DENNIS, Seacrest, FL (US); Rachael Dennis MEADOR, Mobile, AL (US)

(72) Inventors: Larry A. BROCK, Panama City Beach, FL (US); Gary M. DENNIS, Seacrest, FL (US); Sharon D. DENNIS, Seacrest, FL (US); Rachael Dennis MEADOR, Mobile, AL (US)

(21) Appl. No.: 18/191,734

(22) Filed: Mar. 28, 2023

(51) Int. Cl. A01M 25/00; A01N 31/02; A01P 15/00

(52) U.S. Cl. CPC A01M 25/00; A01N 31/02; A01P 15/00

(57) ABSTRACT

An apparatus includes an attachment assembly attachable to a prey of a predator and an agent carrier. The agent carrier is secured to the attachment assembly, and operative to release an agent at a time after ingestion of the prey and apparatus by the predator. The combined apparatus and prey are sized to be ingestible by the predator.

### TECHNICAL FIELD

The present disclosure relates generally to apparatuses and methods for delivery of one or more of non-lethal and lethal agents to predators using prey as a vector.

### BACKGROUND

Disruptions to ecosystems by predator species can be significant. For example, non-native predators (and in some cases, native predators) can disrupt prey populations or flora in ecosystems. In Florida, Burmese pythons native to southeast Asia have established reproducing populations over the past several decades and are now considered the apex predator in the Everglades. The pythons prey on birds, mammals, and reptiles. A substantial decline in rabbits after reintroduction of the rabbits in the Florida Everglades correlates to the spread of pythons in both time and space in the Everglades. In Guam, the non-native brown tree snake has produced a top-down trophic cascade—effecting not only prey species in the ecosystem, but non-prey species as well.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The technology disclosed herein includes apparatuses, methods, and computer program products for agent delivery in predator/prey environments. In some examples, an apparatus of the technology disclosed herein includes an attachment assembly attachable to a prey of a predator, and an agent carrier. The agent carrier is secured to the attachment assembly. The agent carrier is operative to release an agent at a time after ingestion of the prey and apparatus by the predator. The combined apparatus and prey are sized to be ingestible by the predator.

In some examples, the apparatus includes an agent carried in the agent carrier. In some such examples, the agent is a non-lethal agent. In some examples, the agent carrier includes at least one chamber made from material more readily dissolvable inside a digestive tract of the predator than outside the digestive tract. In some examples, the agent carrier is a substance from which an agent will leach more readily in a digestive tract of the predator than outside the digestive tract. In some examples, the attachment assembly is an adhesive.

In some examples, the agent carrier includes an electronically controllable agent release mechanism. In such examples, the apparatus also includes a power source, a processor, and memory. In such examples, the processor is in electrical communication with the power source and the agent release mechanism and is operable to execute instructions. The memory is in data communication with the processor and electrical communication with the power source. The memory stores instructions that when executed by the processor cause release of the agent by the agent release mechanism. In some such examples, the instructions cause the release of the agent by the agent release mechanism as a function of time. In some such examples, the agent carrier includes a plurality of chambers and connective plumbing between chambers. In such examples, execution of the instructions causes one of the release of an agent from each of at least two of the chambers independently.

In some examples, the apparatus includes at least one sensor in communication with the processor and operative to sense an ambient condition of the agent carrier. In such examples, the instructions cause the release of the agent by the release mechanism as a function of ambient conditions of the agent carrier as sensed by the at least one sensor.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram of an apparatus is shown, in accordance with examples of the technology disclosed herein.

FIG. 2 a block diagram of an agent carrier is shown, in accordance with examples of the technology disclosed herein.

FIG. 3 is a flow diagram illustrating methods for agent delivery in predator/prey environments, in accordance with examples of the technology disclosed herein.

Appendix A present additional examples of the technology disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Burmese pythons are classed as an invasive species in Florida. They are comparable in size, or larger than, native competitor species and as such have a reduced vulnerability to predation. In addition, pythons have a high reproductive potential, rapid sexual development, and impressive longevity. Typical female pythons can breed every other year, producing twenty to fifty eggs, and can live for more than twenty years. To complicate matters, even experience herpetologists have been demonstrated to be only marginally effective at detecting pythons. Current estimates for the number of pythons in the Everglades range between tens and hundreds of thousands-with higher confidence in the higher end of the range.

While the present disclosure uses lethal harvesting as an example objective, and Burmese pythons in Florida as an example target predator species and ecosystem, examples of the technology disclosed herein can find use in other ecosystems using other predators and prey with less-than-lethal objectives. For example, sterilization of predator species such as wolves using rabbits as a prey species and sterilization agents in ranges where livestock damage is a problem is another application of the present technology.

Examples of the technology disclosed herein use the disbursement of prey outfitted with an apparatus of the present technology to trigger instinctive behavior of a predator. Once the prey and apparatus are ingested, an agent is delivered (for example, a lethal drug) from the apparatus. Whether the predator is native, non-native, or reintroduced; whether the prey is sterile or capable of reproducing; whether the agent is lethal or non-lethal; examples the technology disclosed here can be used to deliver an agent to the predator using a prey. For example, non-lethal agents can be used to sterilize or deliver medicine to a predator.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents

Several aspects of the technology will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

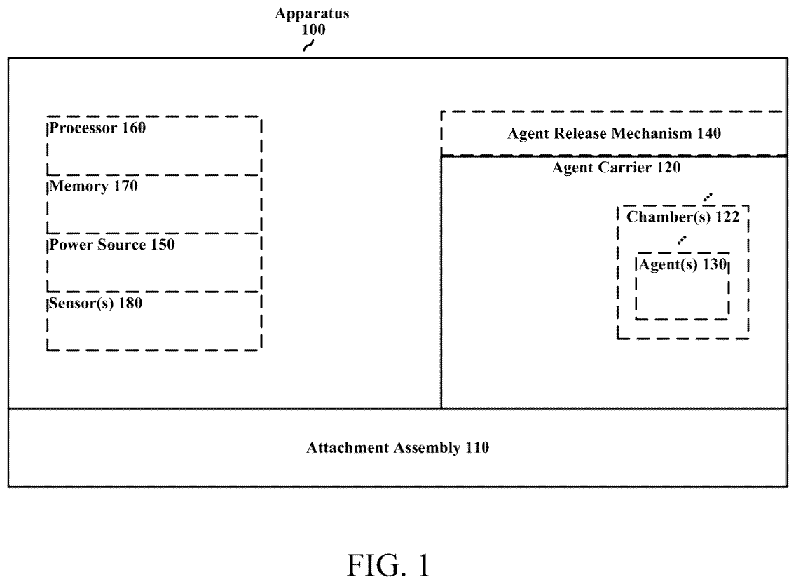

Referring to FIG. 1, a block diagram of an apparatus 100 is shown, in accordance with examples of the technology disclosed herein. The apparatus 100 includes an attachment assembly 110. The attachment assembly 110 is attachable to a prey of a predator. As a continuing example, consider a Burmese python as the predator. The prey is a pullet—fifteen to eighteen weeks old, full plumage. Individual prey are selected to keep the prey weight to apparatus 100 weight manageable for the prey—e.g., between 18:1-20:1.

In this example, the attachment assembly 110 is a chicken saddle, harness, jacket, apron, or feather protector. Chicken saddles can be used to reduce the risk of feather loss on a chicken from over-mating or feather pecking. Such saddles are widely available through mass market online and brick-and-mortar sellers.

Use of a saddle, harness, jacket, apron, or the like also allows the prey to substantially retain freedom of movement and the ability eat and drink. In addition, such attachment assemblies 110 will not prevent the prey and the apparatus 100 from being ingested by the predator. Similar saddles can be adapted for use with various other prey species, such as rabbits. Prey-specific placement and shape of the apparatus 100 depends on prey anatomy, prey weight bearing capacity and strength, and any degree to which placement of the apparatus 100 could interfere with the ability of the animal to survive.

The apparatus includes an agent carrier 120. The agent carrier 120 is secured to the attachment assembly 110. The agent carrier is operative to release an agent 130 at a time after ingestion of the combined prey and apparatus 100 by the predator. Example lethal agents include ketamine and tricaine mesylate. Non-lethal agents include sterilization agents (either temporary or permanent).

In some examples, an adhesive (such as a surgical glue) can serve as the attachment assembly 110 for the apparatus 100. In some such examples, the underside of agent carrier 120 is covered with peel-off sheet to expose adhesive. The agent carrier 120 with an adhesive as the attachment assembly 110 can be placed on the back of the prey, e.g., between the base of the wings and the front base of the tail of a pullet. In some examples, a combination of a chicken saddle and adhesive can be used as the attachment assembly 110.

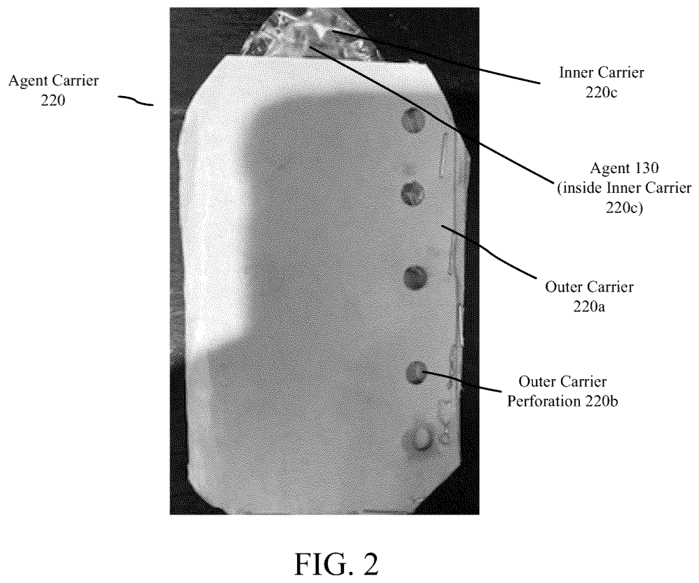

Referring to FIG. 2, a block diagram of an agent carrier 220 is shown, in accordance with examples of the technology disclosed herein. In the example of FIG. 2, the outer carrier 220a is a durable material such as leather or a flexible plastic. Outer carrier 220a is open at both top and bottom, and defines therein outer carrier perforations 220b. In some examples, an outer carrier 220a is integral to the attachment assembly 110, e.g., a pouch in the chicken saddle securable at its opening by a hook-and-loop closure. Outer carrier 220a can be thin unfinished hide or biodegradable plastic container material with glued sealed edge. If leather is used, it is thin unfinished leather. In some examples there is no outer carrier 220a, and the agent carrier 120 is a single piece.

Agent carrier 220 also includes an inner carrier 220c. Inner carrier 220c is a film that is more dissolvable in the digestive tract of the predator than outside the digestive tract of the predator—for example, a digestible plastic such as NotPLA®, a seaweed-based plastic. Upon ingestion of the apparatus 100, the inner carrier 220c dissolves and the agent 130 is released through the ends of the outer carrier 220a and the outer carrier perforations 220b. In some examples, the agent carrier 120 is a substance from which an agent 130 will leach more readily in a digestive tract of the predator than outside the digestive tract.

Returning to FIG. 1, apparatus 100 includes an agent release mechanism 140. In the continuing example, agent release mechanism 140 is electronically controllable, e.g., one or more electronically controllable microvalves and associated plumbing. In such examples, the apparatus also includes a power source 150, a processor 160, and memory 170. The processor 160 is in electrical communication with the power source 150 and the agent release mechanism 140. Further, the processor 160 is operable to execute instructions, e.g., instructions in memory 170. To that end, memory 170 is in data communication with the processor 160 and electrical communication with the power source 150 (or the memory is non-volatile, and power is only needed for operation and not retention). Memory 170 stores instructions that when executed by the processor 160 cause release of the agent 130 by the agent release mechanism 140. In some examples, the power source 150 is a battery. In some examples, the power source 150 includes both a battery and a solar panel for charging/maintaining the battery.

In some examples, the agent carrier 120 includes one or more chambers 122 and connective plumbing between/into/out of chamber(s) 122. In some such examples, the instructions cause one of the release of an agent 130 from the chamber(s) 122 independently using the agent release mechanism 140.

In some examples, the apparatus 100 includes one or more sensor(s) 180, e.g., a temperature sensor, a pH sensor. The pH sensor could, for instance, can be used to determine release of the agent upon an optimum uptake of drugs based on the onset of a high absorption period in a digestive cycle. At least one of the sensor(s) 180 is in communication with the processor 160 and operative to sense an ambient condition of the agent carrier 120 and/or the overall apparatus 100. In some such examples, the instructions cause the release of the agent 130 (in one or more parts) by the agent release mechanism 140 as a function of ambient conditions of the agent carrier 120/apparatus 100 as sensed by the sensor(s) 180. In some examples, the sensors 180 (analog or digital) directly interface with the agent release mechanism 140 to release the agent(s) 130. Addition sensors and electronic can also be includes, e.g., a global positioning system (GPS) receiver for tracking the prey and predators (once the predator has ingested the prey) and a transmitter for transmitting/broadcasting the location of the apparatus.

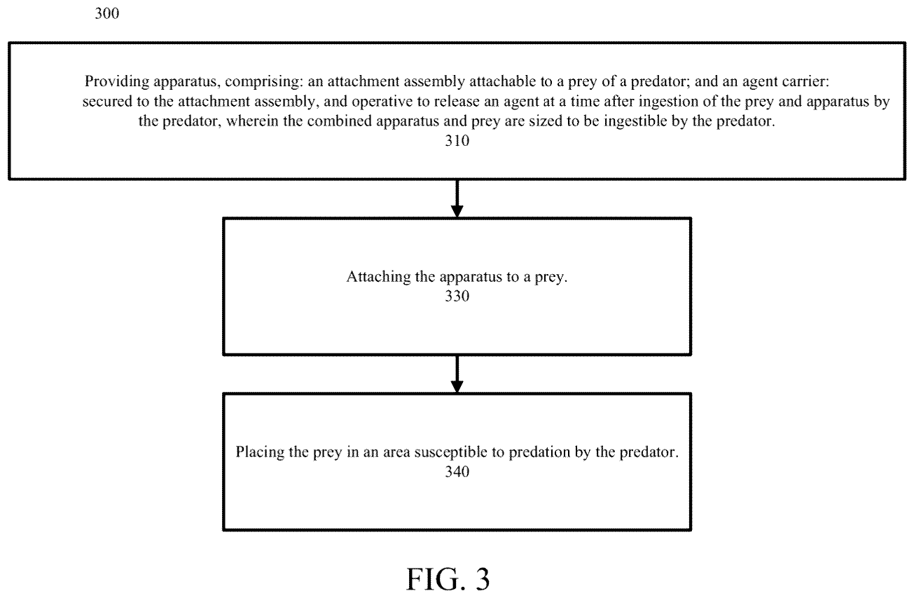

Referring to FIG. 3, and continuing to refer to prior figures for context, methods 300 for agent delivery in predator/prey environments are illustrated, in accordance with examples of the technology disclosed herein. In such methods, an apparatus is provided—Block 310. The apparatus 100, as described in conjunction with FIG. 1 above, includes an attachment assembly 110 attachable to a prey of a predator; and an agent carrier 120 secured to the attachment assembly 110, and operative to release an agent 130 at a time after ingestion of the prey and apparatus 100 by the predator. The combined apparatus 100 and prey are sized to be ingestible by the predator.

As a further example, consider 200 proof alcohol (undiluted ethanol) as a lethal single-drug agent 13, a pullet as the prey, and a Burmese python in the Everglades as the predator. The agent carrier 120 is relatively flat to lower the profile of the apparatus 100 and make it easier for the prey to swallow. For example, agent carrier 220 as discussed in connection with FIG. 2 having an inner carrier 220c of leakproof digestible plastic. The outer carrier 220a is thin unfinished hide with glued sealed edge.

The apparatus is attached to the prey—Block 320. In the further example, starting with a dry pullet, an adhesive attachment assembly 110 and two containers are used. Container #1 holds pre-prep birds and container #2 holds the post-prep birds. Container #2 will eventually go directly onto a delivery vehicle. One person captures each bird and places their non-dominant hand underneath the bird and grasps both legs while cradling the bird. A second person then slides his/her dominant hand underneath the base of the wings and gently pushes the wing forward while slightly lifting. This exposes the top of the attachment area. The second person removes the top half of the adhesive from the bottom of the agent carrier 120. The second person then centers the agent carrier 120 and places it firmly and as close to the wing base as possible, making sure that the adhesive attachment assembly 110 makes good contact with the bird's plumage. Next, the first person folds the bottom half of the agent carrier toward the bird's head, removing a second section of the adhesive cover, and then presses the bottom half firmly onto the bird's back.

In general, the prey is an animal readily attacked and swallowed by the predator. Prey can be selected based on sharing the ecosystem same space as the predator until disabled or consumed. The prey wanders around in the predator's habitat until attacked and consumed by the predator. The prey can carry (in the apparatus) the drugs used to euthanize as an implant. In this case a carrier may not be necessary. The shape of the agent carrier and overall apparatus permits the prey and the apparatus to be ingested by the prey. In some examples, the apparatus does not prevent the prey from eating, drinking, and easily moving around the territory inhabited by the predator.

The prey, with the apparatus attached, is placed in an area susceptible to predation by the predator—Block 330. In the present example, the prey with the apparatus attached can be placed on a “tree island” expected to be frequented by Burmese pythons. A tree island is a variety of tropical hardwood hammock. There are numerous Federally listed animals that depend upon or utilize tropical hardwood hammocks, e.g., the Florida panther, the eastern indigo snake, and the Key deer—each of which is either prey or competitor for resources of the invasive Burmese python.

In some examples, the agent 130 is a single stage drug that will euthanize the predator. Regardless, once the prey is ingested by the predator, a predetermined number of stages will begin. E.g., one agent 130 in a single chambered agent carrier 120 secured by an attachment assembly 110 to the prey. This configuration permits the agent carrier 120 reservoir holding the agent 130 to begin deterioration during the digestive process and ultimately releasing the agent 130.

In some examples, the agent carrier 120 has multiple chambers of varying size and shape for each stage of the agent delivery process. Some predator species will require a multistage approach where multiple chambers will contain various drugs or a mix of drugs. For instance, stage 1−n may be drugs to sedate the predator and stage n+1 might contain the final-stage drug. The multiple chambers can be nested with each nest level containing agent dosage. In such a nested chamber arrangement, the agents can be the same or different and each agent may be lethal or non-lethal. In some examples, the agent carrier 120 includes more than one chamber 122. In some such examples, chamber(s) 2−N are nested. For example, two agent(s) 130 would require that chamber one containing agent one plus the whole of chamber two containing agent two. Predator digestion of chamber one would release agent one and begin digestion of chamber two in order to release agent two. In this case the predator digestive system acts as the agent release mechanism and the process of digestion acts as a timing mechanism for agent two release.

In some examples, instead of an attachment assembly, the agent carrier is implantable in the prey. An implantable carrier contains a drug lethal or nonlethal to the predator. Implanting such a capsule under the skin of the prey would not kill the prey or release the agent. The digestion of the prey will eventually release the agent(s).

In some examples, the agent includes a mechanical or electromechanical agent, for example, one method of retiring the predator is the deployment of a capacitor agent to stop the heart of the predator.

The following examples are illustrative only and aspects thereof may be combined with aspects of other embodiments or teaching described herein, without limitation. The technology disclosed herein includes method, apparatus, and computer-readable media including instructions for wireless communication.

In Example 1, an apparatus of the technology disclosed herein includes an attachment assembly attachable to a prey of a predator, and an agent carrier. The agent carrier is secured to the attachment assembly. The agent carrier is operative to release an agent at a time after ingestion of the prey and apparatus by the predator. The combined apparatus and prey are sized to be ingestible by the predator.

In Example 2, the apparatus of Example 1 includes an agent carried in the agent carrier. In some such examples, the agent is a non-lethal agent. Example 3 includes the apparatus of any one of the prior examples, wherein the agent carrier includes at least one chamber made from material more readily dissolvable inside a digestive tract of the predator than outside the digestive tract. Example 4 includes the apparatus of any one of the prior examples, wherein the agent carrier is a substance from which an agent will leach more readily in a digestive tract of the predator than outside the digestive tract. Example 5 includes the apparatus of any one of the prior examples, wherein the attachment assembly includes an adhesive.

Example 6 includes the apparatus of any one of the prior examples, wherein, the agent carrier includes an electronically controllable agent release mechanism. In such examples, the apparatus also includes a power source, a processor, and memory. In such examples, the processor is in electrical communication with the power source and the agent release mechanism and is operable to execute instructions. The memory is in data communication with the processor and electrical communication with the power source. The memory stores instructions that when executed by the processor cause release of the agent by the agent release mechanism. Example 7 includes the apparatus of any one of the prior examples, wherein the instructions cause the release of the agent by the agent release mechanism as a function of time. Example 8 includes the apparatus of any one of the prior examples, wherein the agent carrier includes a plurality of chambers and connective plumbing between chambers. In such examples, execution of the instructions causes one of the release of an agent from each of at least two of the chambers independently.

Example 9 includes the apparatus of any one of the prior examples, wherein the apparatus includes at least one sensor in communication with the processor and operative to sense an ambient condition of the agent carrier. In such examples, the instructions cause the release of the agent by the release mechanism as a function of ambient conditions of the agent carrier as sensed by the at least one sensor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus, comprising:
an attachment assembly:
attachable to a prey of a predator,
comprising one or more of a saddle, a harness, a jacket, and an apron, and
adapted to secure an agent carrier; and
an agent carrier:
secured to the attachment assembly, and
operative to release an agent at a time after ingestion of the prey and apparatus by the predator,
wherein the combined apparatus and prey are sized to be ingestible by the predator.

2. The apparatus of claim 1, further comprising an agent carried in the agent carrier.

3. The apparatus of claim 2, wherein the agent is a non-lethal agent.

4. The apparatus of claim 1, wherein the agent carrier comprises at least one chamber comprising material more readily dissolvable inside a digestive tract of the predator than outside the digestive tract.

5. The apparatus of claim 1, wherein the agent carrier is a substance from which an agent will leach more readily in a digestive tract of the predator than outside the digestive tract.

6. The apparatus of claim 2, wherein the attachment assembly comprises an adhesive.

7. The apparatus of claim 1:
wherein the agent carrier comprises an electronically controllable agent release mechanism;
further comprising:
a power source;
a processor, in electrical communication with the power source and the agent release mechanism, and operable to execute instructions; and
memory, in data communication with the processor and electrical communication with the power source, and storing instructions that when executed by the processor cause release of the agent by the agent release mechanism.

8. The apparatus of claim 7 wherein the instructions cause the release of the agent by the agent release mechanism as a function of time.

9. The apparatus of claim 7 wherein:
the agent carrier comprises a plurality of chambers and connective plumbing between chambers; and
the instructions cause one of the release of an agent from each of at least two of the chambers independently.

10. The apparatus of claim 7:
further comprising at least one sensor in communication with the processor and operative to sense an ambient condition of the agent carrier;
wherein the instructions cause the release of the agent by the agent release mechanism as a function of ambient conditions of the agent carrier as sensed by the at least one sensor.

11. A method comprising:
providing an apparatus comprising:
an attachment assembly attachable to a prey of a predator and comprising one or more of a saddle, a harness, a jacket, and an apron; and
an agent carrier:
secured to the attachment assembly, and
operative to release an agent at a time after ingestion of the prey and apparatus by the predator,
wherein the combined apparatus and prey are sized to be ingestible by the predator attaching the apparatus to a prey; and
placing the prey in an area susceptible to predation by the predator.

12. The method of claim 11, wherein the apparatus further comprises an agent carried in the agent carrier.

13. The method of claim 12, wherein the agent is a non-lethal agent.

14. The method of claim 11, wherein the agent carrier comprises at least one chamber comprising material more readily dissolvable inside a digestive tract of the predator than outside the digestive tract.

15. The method of claim 11, wherein the agent carrier is a substance from which an agent will leach more readily in a digestive tract of the predator than outside the digestive tract.

16. The method of claim 12, wherein the attachment assembly comprises an adhesive.

17. The method of claim 11:
wherein the agent carrier comprises an electronically controllable agent release mechanism;
further comprising:
a power source;
a processor, in electrical communication with the power source and the agent release mechanism, and operable to execute instructions; and
memory, in data communication with the processor and electrical communication with the power source, and storing instructions that when executed by the processor cause release of the agent by the agent release mechanism.

18. The method of claim 17, wherein the instructions cause the release of the agent by the agent release mechanism as a function of time.

19. The method of claim 17, wherein:
the agent carrier comprises a plurality of chambers and connective plumbing between chambers; and
the instructions cause release of an agent from each of at least two of the chambers independently.

20. The method of claim 17:
further comprising at least one sensor in communication with the processor and operative to sense an ambient condition of the agent carrier;
wherein the instructions cause the release of the agent by the agent release mechanism as a function of ambient conditions of the agent carrier as sensed by the at least one sensor.
